(19) United States
(12) Patent Application Publication
(10) Pub. No.: US 2008/0201190 A1
(43) Pub. Date: Aug. 21, 2008

(54) System and method for electronic processing of default case files

(75) Inventors: William H. Compton, Rockwall, TX (US); Charles R. Haag, Dallas, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Barrett Burke Wilson Castle Daffin & Frappier, L.L.P., Addison, TX (US)

(21) Appl. No.: 11/458,762

(22) Filed: Apr. 8, 2008

Related U.S. Application Data
(60) Provisional application No. 60/702,502, filed on Jul. 26, 2005.

(51) Int. Cl. G06Q 40/00; G07B 17/02; G06Q 10/00; G06F 17/30

(52) U.S. Cl. 705/8; 705/7; 705/404; 707/104.1; 707/E17.019

(57) ABSTRACT

A system and method for automated processing of default case files including foreclosure and bankruptcy related documents is disclosed. The system and method increases efficiency and reduces errors in the volume processing of case files for issuing foreclosure notices and for generating various documents related to bankruptcy proceedings such as MFR and POC. The method includes receiving a default case file, inputting default information from the default case file to a computer system, the default information comprising data records and digital images from the default case file, reviewing the data records and digital images to verify the validity and accuracy of the default information, electronically signing a notice for issue, and producing the notice using a printer connected to the computer system. The system includes a database server networked to other components in the system such as workstations, printers, scanners, and other document processing equipments. The system provides high level security, such as encryption and protection from malicious code, commensurate with the requirements of a financial institution such as a bank or a mortgage lender.

### FIELD OF INVENTION

The present invention relates generally to automated document processing systems and methods. In particular, the present invention relates to electronic processing of case files relating to loan agreements in default.

### BACKGROUND OF INVENTION

To obtain a home loan, a borrower executes a loan agreement evidenced by a note and security agreement which is secured by the real estate and improvements the borrower purchased with the funds obtained from the lender.

The term “borrower” is used interchangeably with the terms “debtor” or “mortgagor”; the term “lender” is used interchangeably with the terms “creditor”, “mortgagee”, or “mortgage servicer”; and the term “security instrument” and “lien” will also used interchangeably.

If the borrower fails to perform any of the borrower's obligations under the terms and conditions of the loan agreement, the borrower is in default. A typical default arises if the borrower fails to pay the monthly mortgage payment. Upon default, and so long as the lender strictly complies with numerous federal and state laws, the lender can cause the property securing the loan agreement to be sold at a foreclosure sale public auction. Since “foreclosure is a harsh remedy to be resorted to only under the direst circumstances, failure to comply with even the most minute federal or state consumer protection, debt collection, property, title and business statutes related to the enforcement of security interest can result in a wrongful foreclosure or class action lawsuit with dramatic economic consequences for the lender.

To enforce a loan agreement that is in default, a lender must create, send by regular or certified mail and file in the real property records of the county where the secured property is located a number legal notices that must contain very specific and precise disclosures depending on the terms of the individual loan agreement, the loan type, investor and numerous other variables. Any deviation from state or federal law or investor guidelines with respect to these variables can result in a wrongful foreclosure or a class action suit. In addition, since the law is never static but constantly changing, the lender must ensure that its collection efforts are always in compliance with current law. Furthermore, the land title records of the county where the secured property is located must be obtained, imaged and carefully examined by title abstractors to determine if any title issues must be cured before the lender can proceed with enforcing its security interest against the property.

Because of all the intricate investor requirements and legal issues involved with enforcing a loan agreement, most lenders retain a mortgage servicer to be their duly authorized agent or representative to handle the day to day loan level administrative details related to a loan. When a loan goes into default the mortgage servicer, as the lender's representative, retains a law firm or trustee company to initiate the debt collection process. The customary business practice of the mortgage banking industry is that the legal services required to enforce a security agreement are set in accordance with investor guidelines, which generally means a flat fee per file. Because a loan in default means the lender is losing interest and opportunity costs, lenders mandate that all loan collection efforts must conform to strict timelines that vary from state to state depending on a particular state's debt collection laws. Another legal consideration that overlays the collection of a delinquent debt is financial privacy concerns require sophisticated encryption and security measures.

A one-digit typo, mistaken address, incorrect loan balance, wrong property description and many other simple mistake in a legal notice or legal instrument that is required in loan agreement enforcement process can invalidate the ultimate sale of the borrower's property. As such, the workflow process associated with conducting process requires exhaustive attention to detail as well as the ability to be extremely flexible so as to adapt to new information that may be received during the collection process from any source, whether from the lender, borrower, the real property records or by borrower's counsel. Further, because each loan file is unique as to loan terms, loan type, property description and priority, the business process requires an inordinate amount of data manipulation and management to ensure that every notice, document or instrument is properly prepared, sent to the correct person and address and filed with the appropriate agencies. In addition the trustee who conducts the public auction must be properly appointed by the note holder or mortgage servicer and the trustee's activities coordinated according to the mandates of the particular loan file.

At any time during the foreclosure process, the borrower can file for bankruptcy, which forces the lender to (a) stop the foreclosure proceeding or otherwise suffer severe economic sanctions from the bankruptcy court, and (b) requires the lender or lender's counsel to deal with the borrower's default under the auspice of the bankruptcy court and the federal bankruptcy code. If the lender determines to seek enforcement of its security agreement that is in default, at a minimum, the lender must timely file a very specific proof of claim (“POC”) with numerous variables in the bankruptcy court to protect its economic interest. Once the POC is filed, the lender then can file a motion for relief of the automatic stay and after obtaining a court order from the court proceed with foreclosure. This legal proceeding requires complying not only with federal bankruptcy law but the local administrative rules adopted by each bankruptcy court which can vary dramatically from court to court even in the same federal district.

Similar to the foreclosure process, the lender's claim against the borrower in bankruptcy court requires both legal skill and attention to detail. Failure to do so can result in drastic consequences to the lender.

Accordingly, a need exists for an integrated system and method for processing of case files in an automated manner. A need exists for a system and method for automatically generating foreclosure notice letters. A need exists for a system and method for automatically generating documents for POC and MFR for electronic filing in a court. A need exists for an efficient, but flexible, method for electronically processing all case information, while providing instant electronic access to required documents. A need also exists for a system that tracks all actions and events related to a case, without adding burdensome workload to the process.

### SUMMARY OF THE INVENTION

The present invention provides a system and method for automated processing of default case files including foreclosure and bankruptcy related documents. The invention increases efficiency and reduces errors in the volume processing of case files for issuing foreclosure notices and for generating various documents related to bankruptcy proceedings such as MFR and POC.

The invention includes a database server networked to other components in the system such as workstations, printers, scanners, and other document processing equipments. The invention provides high level security, such as encryption and protection from malicious code, commensurate with the requirements of a financial institution such as a bank or a mortgage lender. The invention comprises a Case Origination Module, an Electronic Review Module, a Document Generation, Imaging/Indexing Module, and an Administration Module. Additional modules may be appended to the system or a subset of the modules may be implemented to form a specific solution for automating a workflow process.

The invention allows digital imaging and storing of documents relating to a foreclosure or a bankruptcy case file. The invention provides electronic access to foreclosure or bankruptcy case files via an index file that serves as an electronic reference to the documents in the case file. The invention enables review of foreclosure case files and necessary documentation in paperless form, while ensuring that documents remain secure and properly indexed to their associated case. The invention allows an authorized user, such as an attorney, a trustee, or a notary public, to digitally sign official documents and letters in a foreclosure, a Motion for Relief or a Proof of Claim proceedings in paperless form.

The invention provides data structures that link related case files, including foreclosures, MFRs and POCs, which may be stored and processed in physically separate locations, into a master file, such that related case files are automatically indexed in chronological order and made available to a user accessing any case file in the master file. The invention automatically produces hardcopies, e.g., forms, documents, correspondence, and foreclosure notice letters. The invention provides for automatic folding and stuffing of documents in envelopes with electronically administered postage, such that items delivered and returned by a postal service are electronically tracked and linked to the corresponding foreclosure case file to which they pertain.

### BRIEF DESCRIPTION OF DRAWINGS

The foregoing summary as well as the following detailed description of embodiments of the invention will be better understood when read in conjunction with the appended drawings. It should be understood, however, that the invention is not limited to the precise arrangements and instrumentalities shown herein. In the drawings, like reference numerals designate corresponding parts throughout the several views.

The present invention may take physical form in certain parts and arrangement of parts. For a more complete understanding of the present invention, and the advantages thereof, reference is now made to the following descriptions taken in conjunction with the accompanying drawings, in which:

FIG. 1A illustrates infrastructure components including a data processing system in an embodiment of the present invention;

FIG. 1B illustrates core functional modules in an embodiment of the present invention;

FIG. 2 illustrates a module and various steps for issuing foreclosure notice letters in one embodiment of the present invention;

FIGS. 3A-3E illustrate architectural diagrams of functional modules and related steps in one embodiment of the present invention;

FIG. 4 illustrates one embodiment of a master file of the present invention;

FIG. 5 illustrates an Administration module in accordance with one embodiment of the present invention; and

FIGS. 6-19 illustrate examples of user interface panels for a foreclosure notice process in an embodiment of the present invention.

### DETAILED DESCRIPTION

It should be understood that any one of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. These and other objects, features and advantages of the present invention will be more readily apparent when considered in connection with the following, detailed description of embodiments of the invention, which description is presented in conjunction with annexed drawings below.

The embodiments of the invention are described in connection with a system and method for processing case files related to foreclosure (FCL) proceedings. It will become obvious to those skilled in the art that the embodiments of the invention can be adapted or modified to process case files related to bankruptcy proceedings including case files related to a Motion for Relief (MFR) and a Proof of Claim (POC).

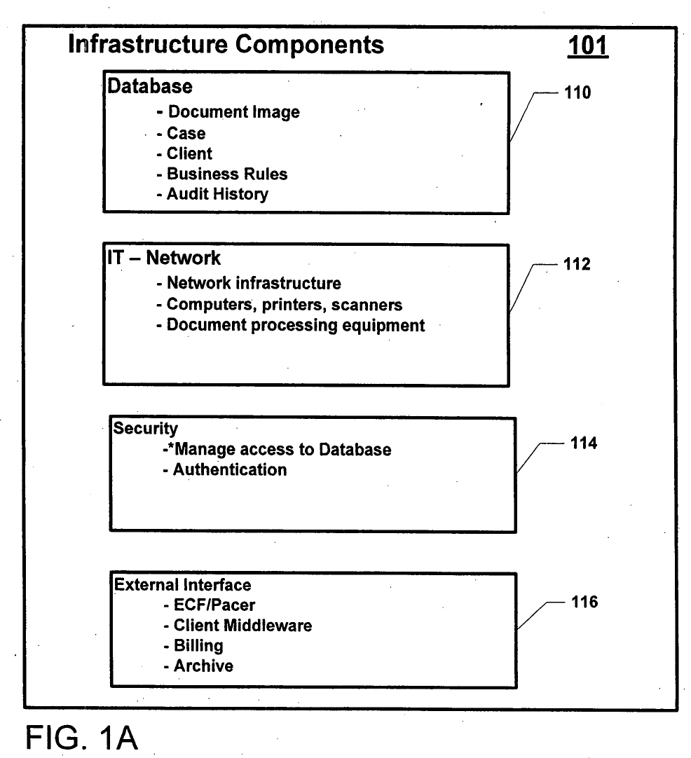

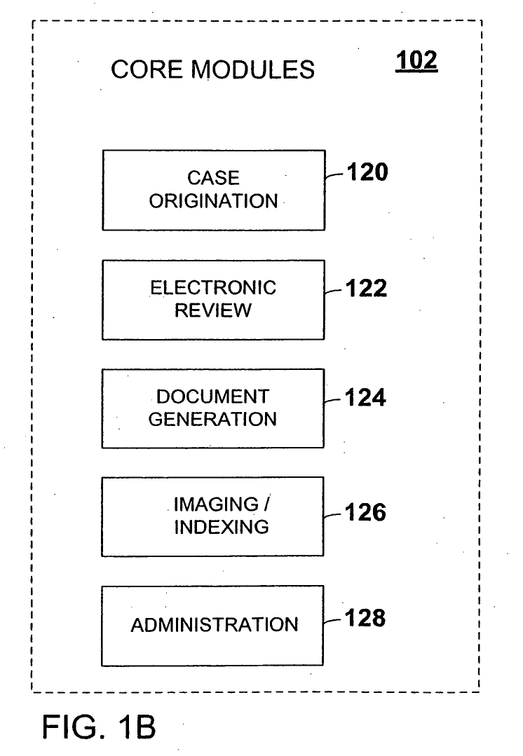

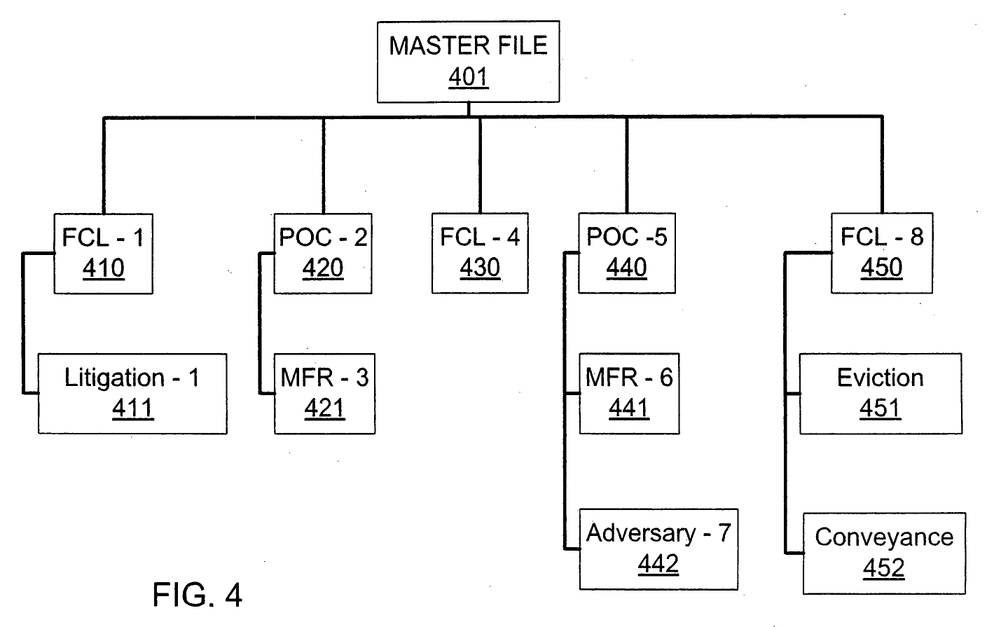

In one example embodiment, the invention is a data processing system 101 as illustrated in FIG. 1A for processing case files related to foreclosures. The database server 110 contains records of users and their access rights, such as those persons qualified to perform electronic review and sign foreclosure notices. The database server 110 contains case indexes and case indexing methods for linking case files (see FIG. 4). The database server 110 contains records pertaining to clients, including their billing information, interfacing requirements, and document preferences. The database server 110 also contains tracking records of time-stamped events and actions taken on the system by operators, with indexing to individual case files, for generating an audit history. In one example case, the tracking records are used to determine performance metrics of individual process tasks, and to record such metrics in real-time as they occur. In one example embodiment, the database server 110 may also contain stored procedures and routines for executing various business rules that govern customization aspects of the method.

The system 101 also includes an Information Technology (IT) Network 112, which includes network infrastructure required to maintain communication between various components of the system 101. The IT-Network 112 may include computers, printers, scanners, and document processing equipment required for automatically processing and generating documents related to foreclosure, POC, MFR and other default related matters. The IT Network 112 is capable of generating notice mailings ready to deliver to a postal service.

The IT-Network 112 and database 110 may be coupled to a high level security layer 114 commensurate with the requirements of a financial institution, such as a bank or a mortgage lender. In one example, the security layer 114 also manages access to the database 110 and is responsible for authenticating users and providing access to the IT-Network 112.

The system 101 also includes external interfaces 116, which are operative to interface with external entities, such as clients of a law firm, courts, financial institutions, government offices, as well as billing and archiving systems. The external interfaces 116 may allow for interfacing to external systems to be performed manually, with the help of data processing software, via Internet websites, or fully automatically with the use of 3rd party middleware software packages. In one particular example, through messaging and notification via external interfaces 116, the system 101 may respond to events that occur in a bankruptcy proceeding that may cause a foreclosure to be initiated or a pending foreclosure to be resumed.

As will be appreciated, the system 101 represents an architecture platform that is operative for enabling users to work in a totally paperless manner. The external interfaces 116 include modules for interfacing with external entities to enable document transfer or to refer a case file and related data. In one embodiment, the invention includes connectivity tools for interfacing through client middleware packages to provide information to trigger to billing systems, and to provide documents and data to archiving systems. In one example, foreclosure referrals may be generated through FCL Addison. In still other examples, electronic client referrals are processed through commercial middleware packages such as Vendorscape™ (First American Corp.), Lenstar™ (Fair Isaac), and Newtrak™ (Fidelity National Financial).

As discussed before, the invention provides a system and a method for automated processing of default case files such as foreclosures and bankruptcies.

FIG. 1B illustrates core modules 102 of a foreclosure notice system in accordance with an embodiment of the invention. As will be understood by those skilled in the art, the core modules 102 can be adapted or modified for use in automated processing of MFR or POC related cases.

In one example, the core modules 102 are client applications implemented in computer program code that interfaces with the database server 110 in a client-server mode. The core modules include Case Origination 120, Electronic Review 122, Document Generation 124, Imaging/Indexing 126, and Administration 128. The modules interact with each other and also with External Interfaces 116 for input and output of foreclosure case file documents. Additional modules may be appended to the system or a subset of the core modules may be implemented to form a specific solution for automating a foreclosure workflow process.

Note that as a result of the virtual (i.e., paperless, electronic) nature of the foreclosure case file, whereby access to the case file may be obtained with any data processing system capable of establishing a network connection to the database, the module steps can be performed at physically different locations, independent of each other, without detriment to the efficiency or quality of the workflow processes.

The present invention makes widespread use of a data structure called a worklist, which refers to a table of items scheduled for processing by a specific task to which the worklist is associated. In one example, a worklist contains a list of foreclosure case files which represent the items ready for processing by a task coupled to the worklist. A worklist may be organized in an ordered manner, such that the first item of the list is assigned highest priority and must be processed before any other times. The worklist may also be used to distribute workload in a parallel manner to a plurality of individuals in a workgroup who perform the same task simultaneously. The worklist may also be used to distribute work according to a predefined criteria or dependence on any given data field in the database. In one instance, the mechanism by which a worklist is generated and may operate is governed by business rules that are defined for the task to which the worklist is coupled.

The act of ‘forwarding’ refers to the action of entering or changing elements in a particular worklist for a processing task, with the effect of transferring pendency of the particular case file from the previous originating worklist to a new destination worklist. In one example, an entry for a case file is deleted from the originating worklist and inserted into the destination worklist. In another example, the status of the case file entry is changed to inactive in the originating worklist and in response, changed to active in the destination worklist. These actions have the effect of transferring the item for processing between the tasks to which the worklists are coupled.

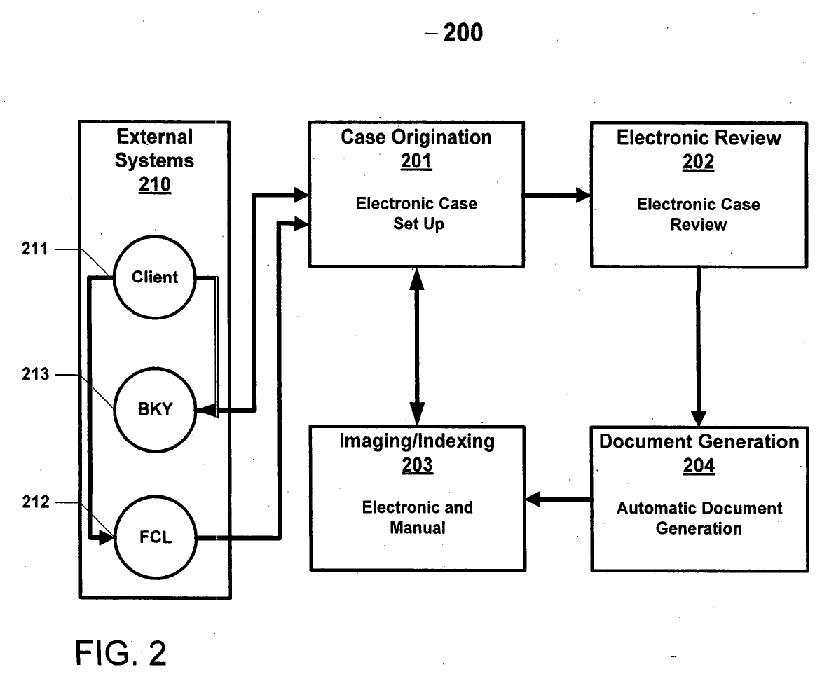

FIG. 2 illustrates module 200 and various steps for issuing foreclosure notice letters in one embodiment of the present invention. In one example, elements in external systems 210 comprise external entities where cases originate, including clients 211, foreclosure case origination 212, and bankruptcy case origination 213. In one instance, the case origination module 201 generates new cases and prepares case files for subsequent downstream operations.

An electronic review module 202 receives the virtual case files by a transfer of a database index from the case origination module 201. In one example, a database index for a foreclosure case file that has been originated in module 201 is transferred to a worklist of pending cases for electronic review at the electronic review module 202. The electronic review module 202 provides methods for the review of legal documents by an attorney, a trustee, a notary public, or other qualified person, and in particular comprises a means for electronic signature of documents by the reviewing person. In one exemplary implementation of the present invention, access rights in module 202 for electronically signing foreclosure notices are granted in response to special security measures, such as separate passwords and authorization timeout for the electronic signature function.

A document generation module 204 receives the virtual case files from the electronic review module 202. The document generation module 204 provides workflow processes associated with automated document generation involving generating, printing, mailing, electronically transferring documents. Documents may comprise notice letters and other legal correspondence to external entities. The transfer of foreclosure case files from module 202 to module 204 may occur via copying of case file indices into worklists, in an analogous manner to previously mentioned transfer methods. In one embodiment, the present invention may provide for collecting a plurality of foreclosure notices that have been approved for printing and mailing in a worklist or batch, which may be released for automatic printing with a single authorization command. At any time prior to printing and mailing, the document generation module 204 permits the removal of any given pending foreclosure notice from the worklist, in response to external events that may forestall foreclosure.

An imaging/indexing module 203 receives documents and cases from the case origination module 201 or from document generation 204. The transfer of foreclosure case files from module 201 may occur via copying of case file indices into worklists, in an analogous manner to previously mentioned transfer methods. Documents in foreclosure case files may also be provided to imaging/indexing 203 from other internal or external entities manually or automatically. Of particular notice in FIG. 2 is the capability for automatically and manually indexing electronic images of documents to the appropriate foreclosure case file, by coupling each document image file to a database index. The module 203 also provides the capability of storing electronic images of issued foreclosure notices and any returned postal items in the database, indexed to the virtual case file.

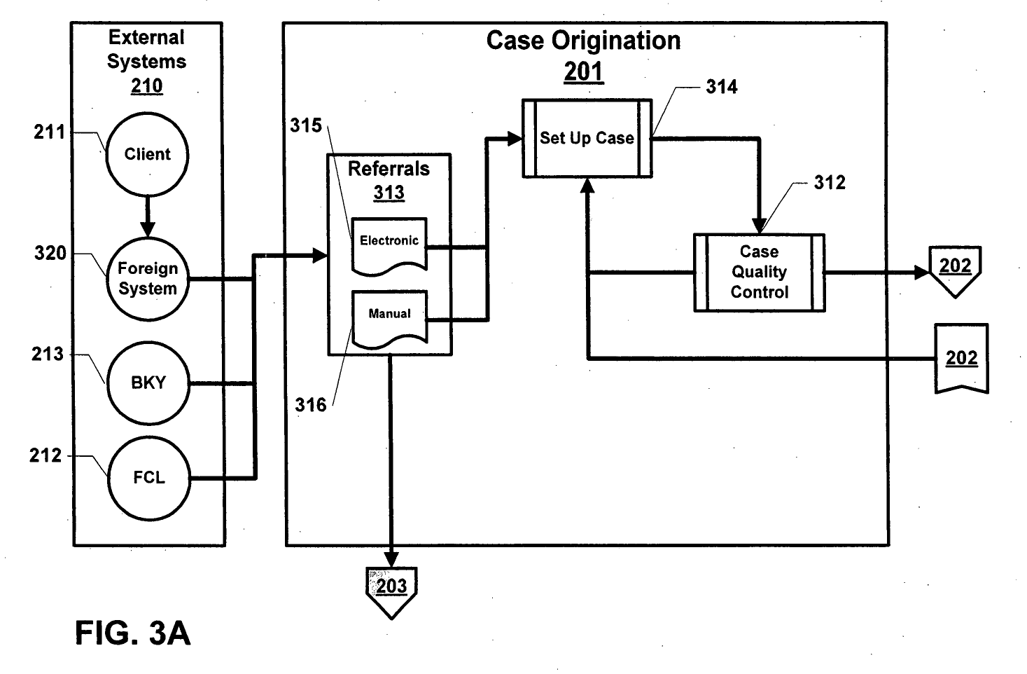

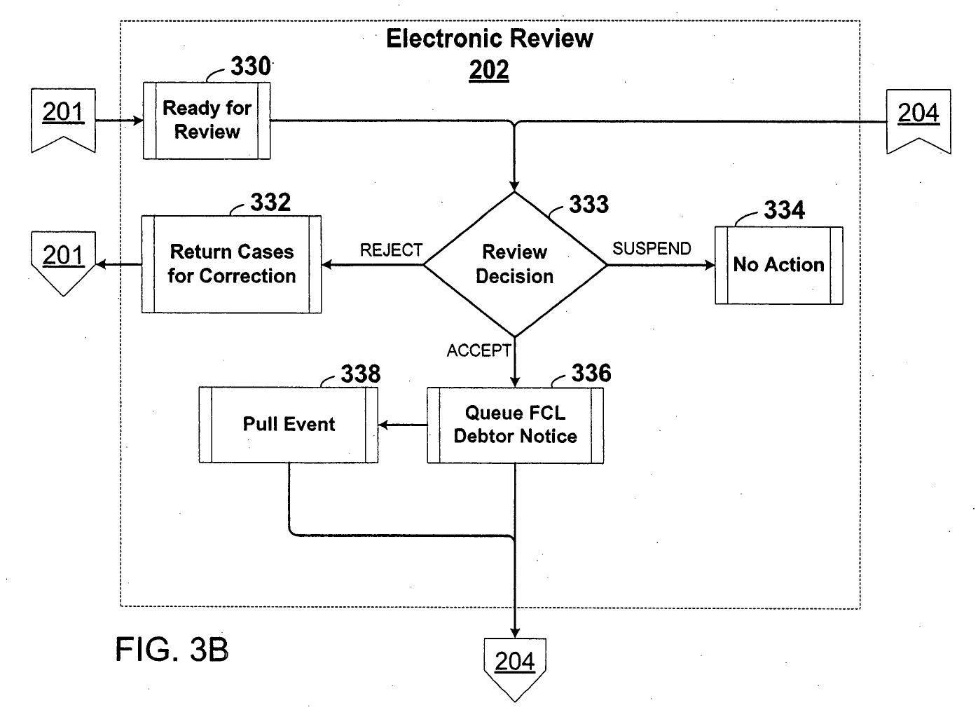

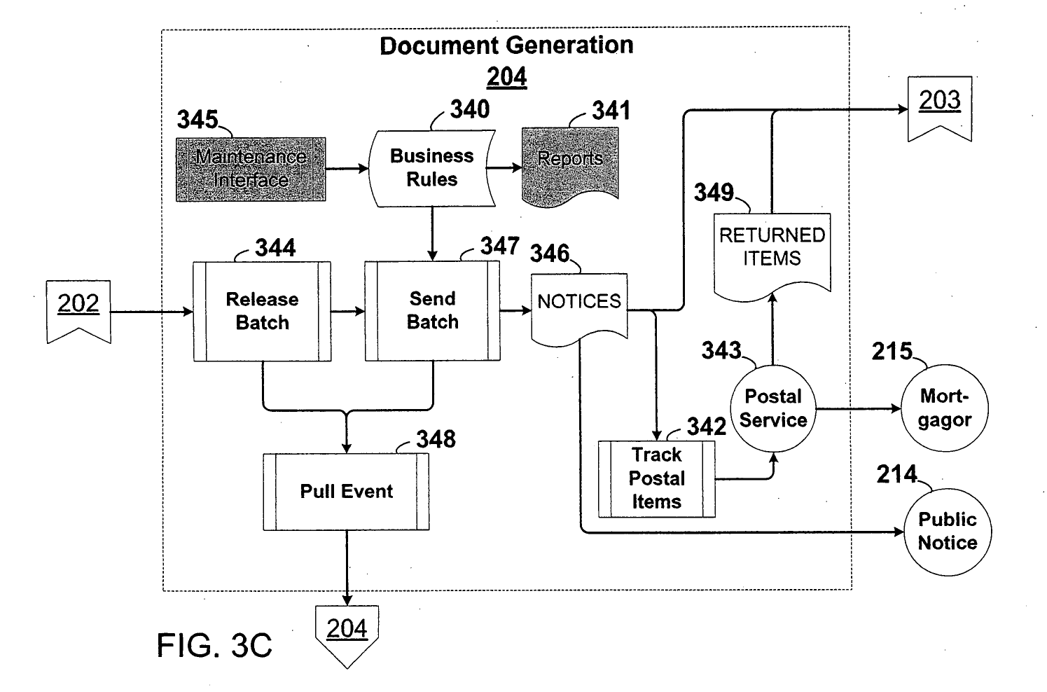

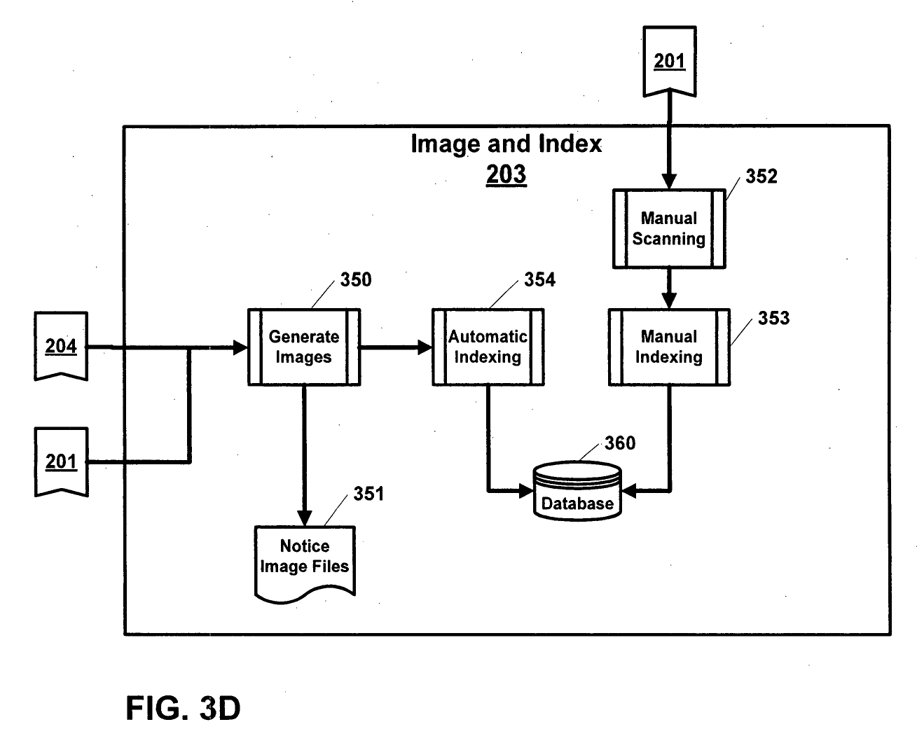

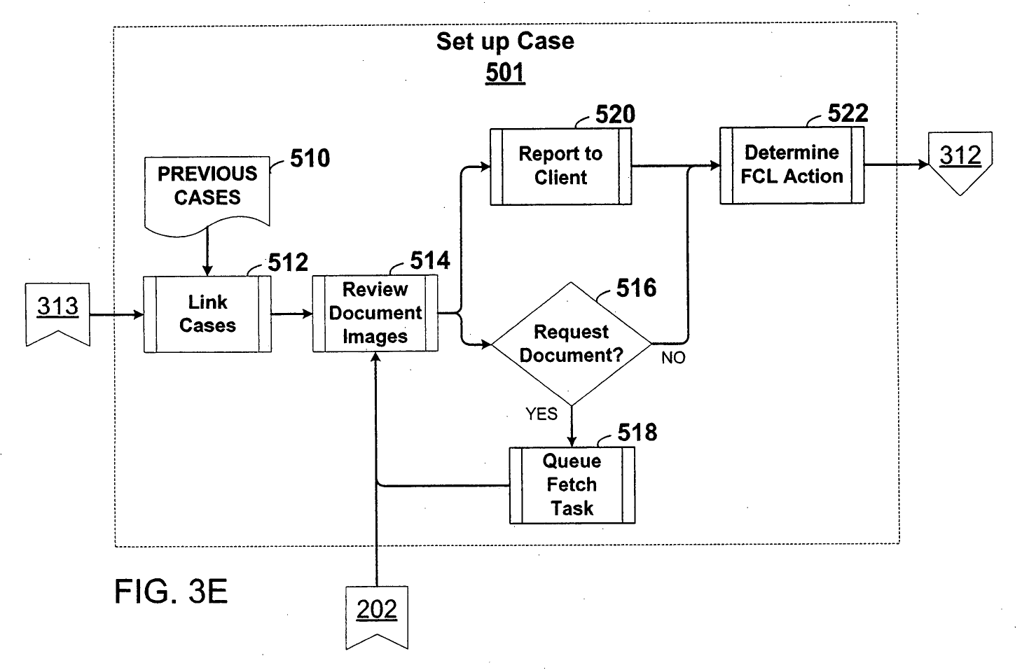

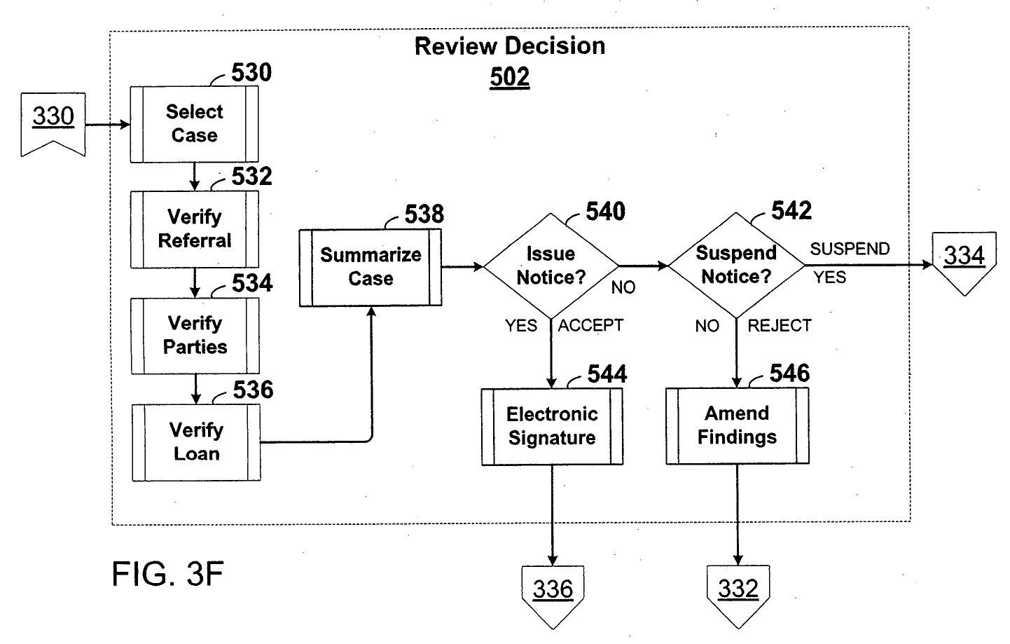

FIG. 3A illustrates the case origination module 201 in detail with its relationship to the external systems 210. The case origination module 201 includes a referrals module 313 that receives a referral in electronic or manual form. In case of a manual referral 316 originating from a client 211 any physical documents are forwarded to manual scanning 352 and manual indexing 353 in the imaging/index module 203 (see FIG. 3D). Electronic referrals 315 may be entered by a client 211 into a foreign system 320, which may comprise a middleware for entering the details of the case and automatically forwarding the case file to referrals module 313. Electronic referrals of incoming foreclosure cases may originate as bankruptcy referrals 213, or from foreign systems 320 which may refer cases electronically 315. In one example, a foreign system 320 provides notification that a foreclosure referral is available for origination, and provides instructions for retrieving the referral electronically 315. Upon electronic receipt of a case in referrals module 313, the case file is directly forwarded for a case set up to a case setup module 314. In response to review of the foreclosure documents and electronic acquisition of other required documents in the case set up 314, a quality control step 312 is performed to assure that all information is valid, consistent, and accurate, according to the underlying documents in the foreclosure. In one example of a foreclosure quality control step in 312, the name of the mortgagor and the address of the property are checked between title documents and loan documents. One example of a result of control step 312 is that a request for clarification or further documents may be made if additional information is required in the case. After the case has been set up 314, the quality control 312 has been performed and proper course of action for the foreclosure has been determined, the case origination module 201 has completed its work with the case and forwards the case for electronic review 202.

At the output stage, the module 201 may also contain a case origination queue (not shown in the drawings), which is capable of buffering case files until they are complete, or simply holding them back over other case files which have been assigned higher priority. The priority of foreclosure case files may be raised in the case origination queue, as in other modules of the present invention, to facilitate expedited processing of urgent case files, or those that become urgent at a certain point in time while they are under processing, or as defined by business rules governing case file priority. The result of raising the priority of a case file in the case origination module 201 includes advancing the case file in the output portion of the case origination queue. Cases also return from electronic review 202 to case origination 201 upon error, for further processing, or for other reasons why the case file needs further attention by set up 314 in the case origination module 201.

FIG. 3E illustrates various steps involved in the case set up process 501 in detail with related modules in accordance with one embodiment of the invention. The implementation of case setup 501 may replace in one instance the case setup 314 shown in FIG. 3A. In FIG. 3E, the first step after referral 313 is case linking 512 to previous cases of record in the system 510. The case linking 512 results in the master file structure, as shown by example in FIG. 4, and involves a chronological ordering of cases related by name, property address or other common feature. In this manner, a foreclosure case file may be processed within an integrated system that is capable of handling various legal proceedings involving a single debtor (see FIG. 4). The next set up step in FIG. 3E is review of the document images 514. Note that step 514 may also commence upon rejection and return of the case file to case origination 201 from electronic review 202. In step 514, the case documents are checked for completeness and accuracy. In one example, after review of document images 514, the foreclosure case file has been issued a unique database index which is used to couple all information and documents to this case. A report confirming receipt and acceptance of the foreclosure referral may be issued in step 520 to the referring client. Concurrently, a determination may be made in step 516 to request additional documents, thereby initiating a document fetch task. In various embodiments of case setup 501, steps 520 and 522 may be omitted or executed in a different order. If additional documents are requested, a fetch task is queued and a request for retrieval of the required document issued in step 518. A pending fetch task in step 518 serves to hold the foreclosure case in case origination 201 until the document is returned, at which time an event is generated providing notification of the fulfillment of the document request. In one instance, a tracking number used to define the fetch task is also used in the filename of the imaged documents. In one example, a foreclosure case requires the retrieval of title documents, and initiates a title search request in step 518 with an entity that provides title services. After a document has been fetched in step 518, the case file will be subjected to another review of all document images in 514. This process may repeat until no further documents are required, such that the case file is considered complete. In step 522, after entry of information fields and verification of foreclosure documents, a determination may be made as to what kind of foreclosure action is recommended in the present case. After the case file has been initialized, the system may determine in 522 the further processing steps for the case file through specific business rules, which may depend on inputs from the referring entity, the merits of the case as presented, an analysis of the documents in the file, or other dependencies in any combination with deadlines, actions, or results. The determination 522 may take into consideration the dates of previous foreclosure notices that have been served upon the borrower, such as notice of default, demand letters, and acceleration letters.

FIG. 3B illustrates the electronic review module 202 and the steps executed for processing and reviewing case files by an authorized person, such as an attorney, a trustee, a notary, or any other authorized person. From the case origination module 201 the cases are entered into a worklist 330 showing which cases are ready for review. The worklist 330 is linked to stored data comprising images, links and comments. The stored data is individually linked to foreclosure case files in the work list 330. A review decision 333 begins when a particular case is selected for processing. The reviewing person reviews the case documents, reviews the desired action on the case and makes a decision from one of several options. One option is to reject or return the case for correction 332 back to the case origination module 201. Another possible course of action resulting from the review decision 333 may be that the case is entered into a waiting queue 336 or that no action is taken at the present time 334. The case may be withheld (i.e., no action 334) pending the occurrence of certain events, deadlines, or other rule-based actions as determined by the business rules governing the suspension process. In one example of automation, cases held waiting for events to occur, such as a response by a debtor or the passing of a deadline, may be entered in a queue, after which the case reappears in a timely manner into the incoming worklist 330. Another course of action is that the review decision 333 results in accepting to proceed with legal action on the foreclosure case. In this case, all relevant documents have been reviewed and, if necessary, an electronic signature has been performed in the virtual case file. Upon taking action via step 336, The foreclosure case file is then forwarded to the document generation module 204 for further action.

FIG. 3F shows various steps of a review decision 502 according to one embodiment of the invention. The implementation of the review decision 502 may replace in one instance the review decision 333 shown in FIG. 3A. In step 530, a case is selected from a worklist. As mentioned previously, the worklist may be organized as to distribute cases for review in a workgroup based on priority, a round-robin scheme, or another scheme. Upon selecting a case 530 for review, the reviewer may already select the particular foreclosure notice to send through corresponding business rules and may note the type of letter the reviewer will be reviewing. Upon selecting a case 530, the reviewer may be presented with a guided document review template, such as a user interface panel. The initial verification step 532 may involve verifying a client referral letter to verify the foreclosure referral and attached data. In step 532, the image of the referral letter may be inspected and reviewed. Next, the reviewer may verify the parties of interest 534. In one example, the reviewer selects a mortgagors tab in the review template and verifies the names against images of the deed of trust and the referral letter. The reviewer makes sure that all parties are consistent among the documents and makes corrections to the foreclosure notice data accordingly. The reviewer may also check the addresses to assure correct address for the foreclosure property. The address may also be checked against the deed of trust and the referral letter. Again the reviewer is responsible for ensuring that all address information is valid, accurate, and consistent, such that the foreclosure notice issued with the entered information will be legally binding. In one example, the reviewer may open in step 534 a Mailings tab and check to assure that all property parties in interest are properly identified and addresses are complete.

In step 536, the reviewer verifies loan information 536 by viewing the original loan documents. In step 536, the reviewer may check information in the deed of trust and the referral letter with a lien instrument, if available. Of particular importance in step 536 is the unpaid principal balance, whereby the due date of the unpaid principal balance and the original principal balance are also verified. Another check in step 536 may be the type of the loan. Once again information is checked against the referral letter and deed of trust. The loan type is an important check in step 536, because the case may be sent along another foreclosure path depending on the type of loan. In one instance, the reviewer may identify that the property is a mobile home unit and select the pertinent foreclosure notice for issue.

The reviewer may then summarize the findings in the case in step 538. In one example implementation, the reviewer may opens a Finish tab on the review template and view a screen which summarizes all the checks completed. In one case, a summary screen includes a Review Findings area that allows the reviewer to identify issues and make comments if a case is to be returned for correction, or for any comment that may be pertinent to a future review.

After summarizing the case in step 538, the reviewer may make an initial decision in step 540 whether or not to issue the foreclosure notice in the present case. If the reviewer chooses YES, the reviewer may provide an electronic signature 544 for the selected foreclosure notice letter, and may require additional validation for that purpose. The electronic signature in the present invention relies upon and is compliant with 15 U.S.C. §7001, Electronic Records and Signatures in Commerce, General Rule of Validity, of which subsection (a) recites:
15 U.S.C. § 7001. General rule of validity
(a) In general
Notwithstanding any statute, regulation, or other rule of law (other than this subchapter and subchapter II of this chapter), with respect to any transaction in or affecting interstate or foreign commerce—
(1) a signature, contract, or other record relating to such transaction may not be denied legal effect, validity, or enforceability solely because it is in electronic form; and
(2) a contract relating to such transaction may not be denied legal effect, validity, or enforceability solely because an electronic signature or electronic record was used in its formation.

The process for electronic signatures in the present invention has been designed to balance the need for adequate security with the need for freedom from overly cumbersome measures for authorization, which would defeat the purpose of the invention of increasing efficiency of the process. In one example, the present invention relies upon Microsoft Windows™ operating systems and the Microsoft.NET™ platform to provide general access and security 144 to the entire system and all available modules. In one example embodiment, when a user attempts to enter the electronic review module 202, the user must provide another proof of authorization, such as an additional user code and password, to release the electronic signature function 544. At this point, the authorized and validated user of the activated electronic signature function is personally responsible for the actions of the system, and must also abide by the governing policies and procedures which have been established by the operator of the foreclosure processing system. In one case, the electronic signature function provides an additional security measure of a timeout of the activation of the authorization to sign electronically, such that upon a period of inactivity as detected by the system, the authorization is automatically revoked, and must be reactivated for further use. The reviewer's signature may be stored on the database as a digital image acquired by scanning a physical signature by the attorney and applying a transparent background color. In one exemplary implementation, the authorized signature is embedded into a digital file of the document to be printed at the time the document is printed in document generation (see FIG. 3C). In one example, the database records the state of all documents that have been authorized with an electronic signature and applies business rules to determine the validity and proper processing of such documents. If the reviewer chooses to sign, the case is transferred into an electronic queue for action by another group to meet the tinting requirements of the notice document. In one implementation, the actual letters are created, with the reviewer's electronic signature, at the time they are printed and mailed, and may be stored in a holding queue until a certain approval or deadline has elapsed. In one case, the reviewer is an attorney-at-law and holds a valid license to practice law, with all the rights and responsibilities of such license. In one embodiment of the present invention, a notary public may electronically sign a letter to validate a signature by another reviewer. The term ‘reviewer’ may therefore be substituted with any equivalent authorized party using a corresponding electronic review module, such as an attorney, notary public performing a notarization, legally binding signatures by agents of record, or official approval of documents by authorized representatives of government and commercial entities.

If in step 540, the reviewer chooses NO, then the reviewer is faced with a second decision in step 542 regarding the case file, whether or not to suspend the notice 542. The act of suspending the foreclosure notice 542 may result in an indefinite suspension of action on the case, removal of the case from foreclosure, a suspension for a definite period of time, or suspension until reactivation in response to an external event or action by a stakeholder is registered. In one example, a deadline for repayment of the amount due is extended to the borrower which forestalls foreclosure. If the reviewer decides not to suspend the notice in step 542, then the reviewer has effectively rejected the foreclosure notice on some grounds, and may return the file to case origination 201 for some additional corrective action or retrieval of additional or corrected documents. The reviewer may amend the findings 546 in the particular case file, including reasons for rejection and a description of required action to remediate the case file.

FIG. 3C shows the steps for automatically creating documents and physically issuing foreclosure notices using the document generation module 204 in accordance with one embodiment of the invention. The document generation module 204 relies on business rules 340 for determining various courses of action for case files. The maintenance interface 345 is used to update and review the business rules and to add additional business rules 340 as is required for normal maintenance of the system. The business rules 340 determine which documents are to be signed and in what manner they are to be signed.

The document generation module also permits the generation of internal reports as shown in step 341, comprising statistical or performance measures about the functioning of the entire system 200. The document generation module 204 automatically generates foreclosure notices 346 to be mailed, and mails the documents, according to the business rules 340. In one implementation, the document generation module 204 contains infrastructure required to print and mail a large volume of documents, letters, or notices. The case files for issuing foreclosure notices may be transferred to document generation 201 from electronic review 202 via a worklist, as previously discussed.

In step 344, a batch on a worklist of items ready to be printed, wherein each item represents a particular foreclosure case file that has been reviewed in step 333 and electronically signed, may be released for printing and mailing. After a batch is released, the batch may be sent to a printing process in step 347. In one exemplary implementation, the foreclosure notice documents 346 are electronically assembled for printing. These documents 346 may comprise a cover page, a foreclosure letter signed by an authorized individual (such as a practice group attorney), and a legal description of the real property being foreclosed upon. In one example, individual fields in the document 346, such as an identifying loan number, name and address fields, and a bar code of a case file index are retrieved from the database and used to generate a specific letter for a borrower in default. In one case, a bar code is generated that electronically debits a postal charge for each individual item for a specific type of postal service 343, such as certified mail. The bar code number may be used to track each item of postage send using tracking systems provided by the postal service 343. Each document 346 in a batch may thus be processed with individual data in an automatic manner. During the process of releasing 344 and printing 347, a change in the fields of records in the database 360 may result in a pull event 348. In response to a pull event 348, a case file may be pulled from the worklist of items released for printing, but not yet printed. In one example, registration of payment by the borrower of the amount owed may generate a pull event 348. In another example, a bankruptcy filing by the borrower may suspend foreclosure and result in a pull event 348 by changing the status of the foreclosure case file from active to inactive. After printing of all documents 346, the notices may be folded and inserted into envelopes. In one example, the preparation of envelopes is done automatically with a document processing machine. The process of generating notices for mailing may include a step 342 wherein each postal item is recorded and reconciled against each item that was released for printing in step 344. In this manner, a very high degree of certainty is achieved that each foreclosure notice 346 that is electronically released 344 is actually printed and mailed. Further, for any number of reasons, the item of post containing a foreclosure notice 346 may not be deliverable by the postal service 343 to the address provided and may be returned to the sender by the postal service 343. The present invention provides a means for receiving each returned item 349 and then processing each item by the indexing/imaging module 203, where it may be scanned and recorded, and indexed to the foreclosure case file to which it belongs. The indexing of returned postal items may occur manually or automatically with an optical character recognition mechanism. The foreclosure notices 346 generated may be sent by postal service 343 to the mortgagee 215 in default. Foreclosure notices 346 may also be printed in module 204 for public notice 214, such as for recording by a county clerk and public posting at a county courthouse in anticipation of a public sale. An inherent feature of document generation 204 is that documents may be generated independent of location and time as determined by the network capabilities of the system; however, the invention permits restriction through business rules 340 which may be required for compliance with client preferences, internal standards, technological requirements, security requirements, court requirements, government regulations, or other criteria dependent methods.

FIG. 3D illustrates the image and index module 203 and the steps for generating digital images of documents and linking the resulting image files electronically to individual case files. The case file indexing of digitally imaged documents enhances efficiency by reducing the amount of queries required to retrieve a document associated with a particular case file. Foreclosure referral documents are received from clients and are sent to module 203 for manual scanning 352 and manual indexing 353. The present invention provides the means for processing a large volume of printed documents using high-speed industrial scanning equipment and generating a batch of document image files in step 352. In one example of the present invention, the documents are imaged with 1-bit color depth with a spatial resolution of 300 dpi, which is optimal for viewing text documents as digital images, and which limits the data volume per image for faster transfer to all applications accessing the image from the database via a network connection. The manual indexing step 353 may comprise a workgroup of individual who are tasked with electronically viewing each scanned image and indexing or sorting the image for proper storage in the database. In one implementation, the manual indexing 353 may be augmented with an optical character recognition routing that may search for specific information in the document image and convert this to text and enter the text in defined fields. Upon manual indexing 353, the documents are stored in the database 360 and are indexed to a particular foreclosure case file. Another functionality in image and index 203 is the automatic indexing path. In addition to physical printing, the foreclosure notices 346 may be virtually printed 350, whereby virtual printing 350 refers to assembling an electronic image of the document as it would appear in printed form, and storing this in a format that preserves the original appearance. In one case, the well-known PDF format is used to generate data files 351 during virtual printing 350. The virtually printed files 351 may then be stored in a location coupled to the database 360 and may be automatically indexed 354 to the foreclosure case file to which they belong. The step of automatic indexing 354 refers to a process by which the case file index of the document is known in advance and is transmitted with the document image and used by the indexing 354 to store the document image in the database 360. Some documents may be auto-indexed by the system, such as those which were originally sent out via document generation 204, and have been returned and can be recognized by a system-specific digital signature, such as a bar code, that was placed on the document during digital assembly and printing. Through interface with middleware programs (not shown in the drawings), case documents can be automatically linked to case files and master files. Input to image and index 203 may involve intermediate manual steps, such as downloading documents from an external website of a referring entity or retrieving documents sent via e-mail.

FIG. 4 shows a block diagram of a master file 401 in accordance with one embodiment. The invention allows individual case files to be linked to the master file 401. The master file 401 may represent a historical record of actions against a specific debtor, a linking of a specific claim among various debtors, or other types of linking for associated cases. The master file 401 contains chronological links to case file indices that are related by some shared attribute. In one case, the shared attribute is the borrowing entity. In the example embodiment shown in FIG. 4, the first linked case file 410 represents a foreclosure with an associated litigation 411. The next action in the case is a proof of claim 420 filed after the borrower has declared bankruptcy. The proof of claim 420 is accompanied by a motion for relief 421. The next linked file is a second foreclosure proceeding 430. This is followed by a second bankruptcy proceeding and a proof of claim 440, which is coupled to a motion for relief 441 and an adversary action 442. Finally, the master file 401 indicates that a third foreclosure 450 was initiated, which was accompanied by an eviction 451 and a conveyance 452 resulting from a sale of the property.

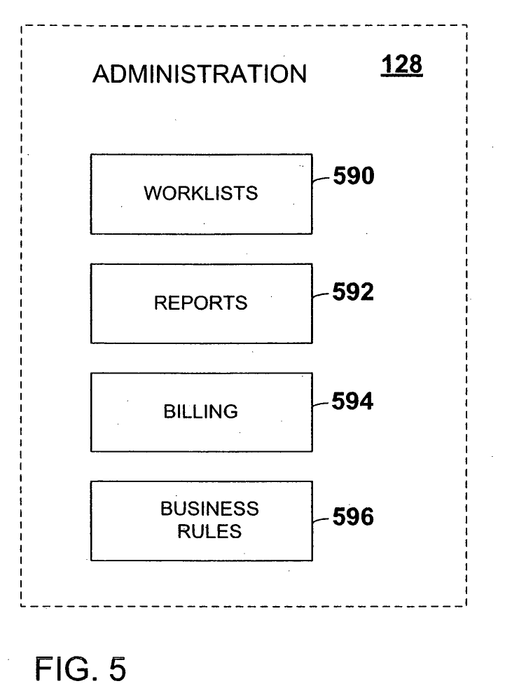

FIG. 5 shows the Administration module 128 in accordance with one embodiment. The module 128 includes Worklists 590, which comprises a list of pending tasks. The module 128 also includes Reports 592, which provides statistical and usage information about data elements, case files, users, and modules. Reports 592 may be defined and customized to provide managers and administrators with views such as tables or graphical charts for quantitative and qualitative performance measures. Billing 594 comprises information on individual case files and the services provided for a given order from a given client. Billing 594 is responsible for maintaining clients and case file accounts up-to-date in real time and for providing consolidated financial data to interface with related financial systems. Business Rules 596 provide rules and procedures that are customizable in terms of client preferences or revised process flow.

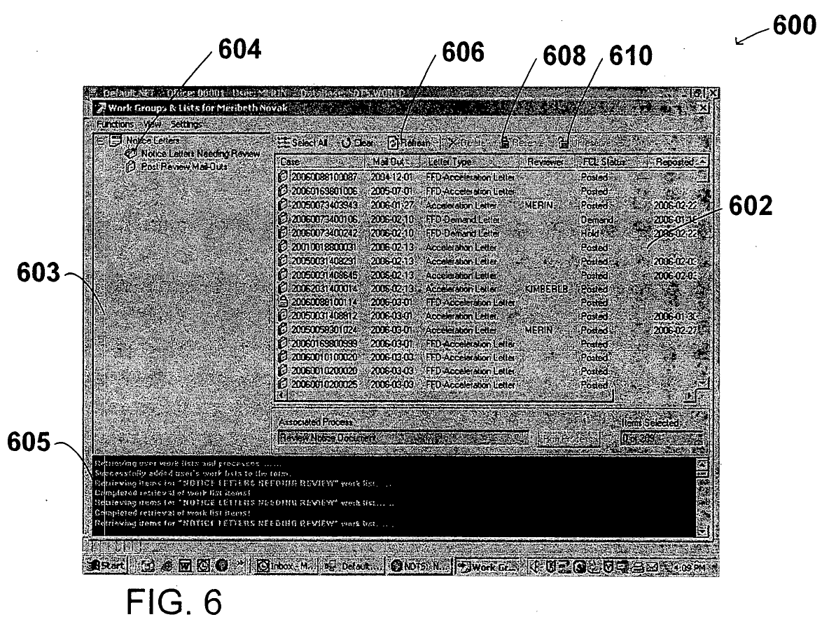

FIGS. 6-19 illustrate user interface panels for an automated foreclosure notice process in accordance with one embodiment of the present invention. The terms pane, panel, and window are interchangeably used to refer to distinct elements in the graphical user interface, generally defined by an outer border.

FIG. 6 shows how pending foreclosure notice orders are managed in the “Notice Letters Needing Review” tab 604 of a main panel 600 via a worklist 602. A left pane 603 is an expandable/collapsible branched tree of notice letters. A right pane shows a worklist table 602, and a lower pane 605 displays status messages and events. A single line in worklist 602 may be used to select (not shown) an individual case file for processing. A user, i.e., reviewer, wishing to process a certain case shown in the worklist 602 may reserve the case file using the Reserve function 608 (shown deactivated) and release the file for processing by other users using the Unreserve function 610 (shown deactivated). The Refresh function 606 updates the status of the fields in the worklist 602 by querying the central database and retrieving the most current values.

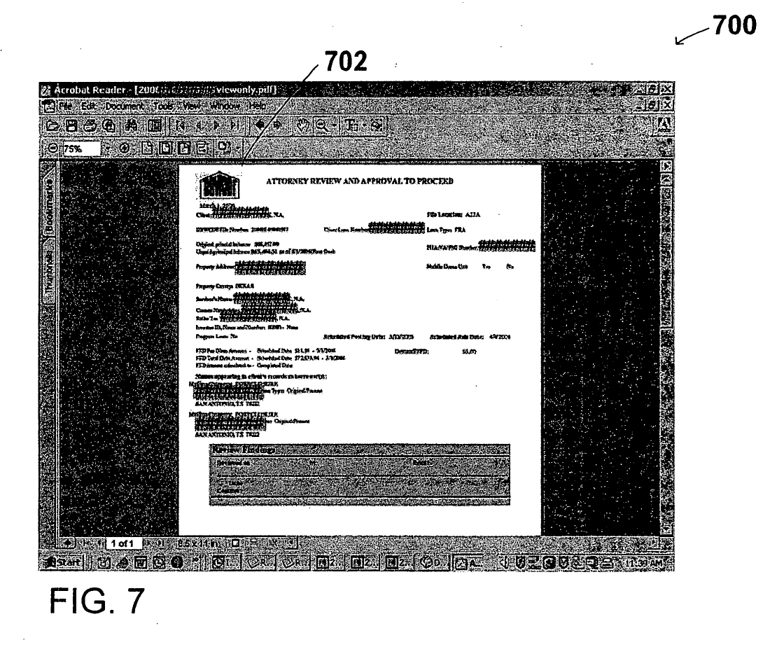

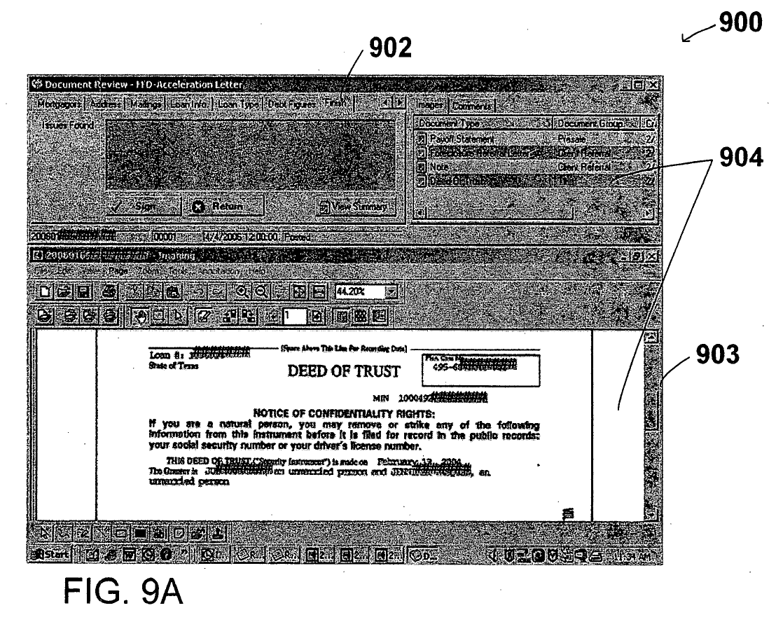

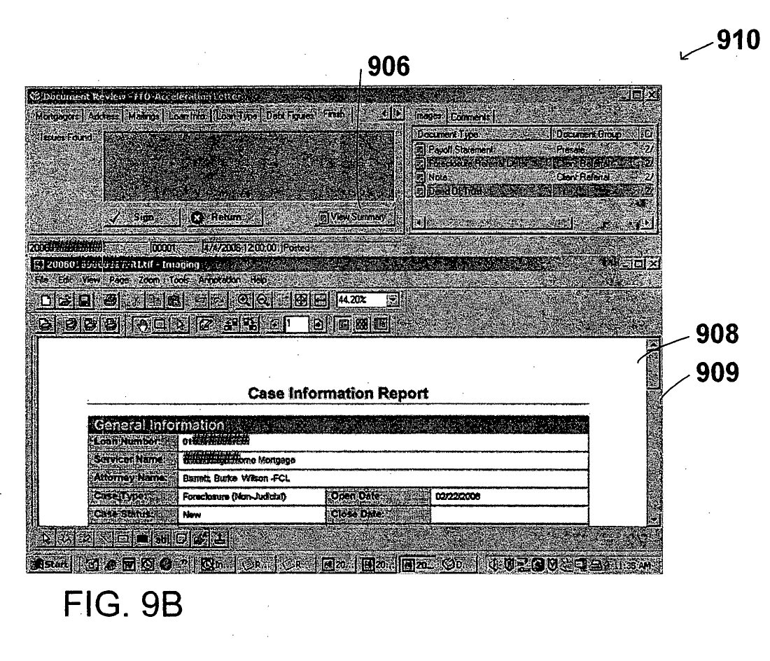

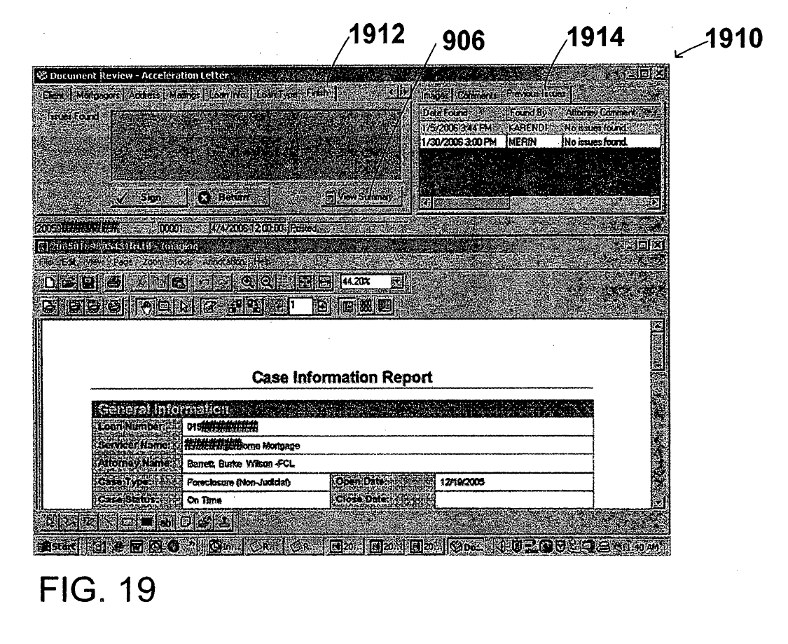

FIG. 7 shows a summary of a foreclosure case file that is ready for signature by an attorney in accordance with one embodiment of the present invention. A panel 700 shows a summary page 702 by activating the View Summary function 1904 (see related FIGS. 9A, 9B and 19).

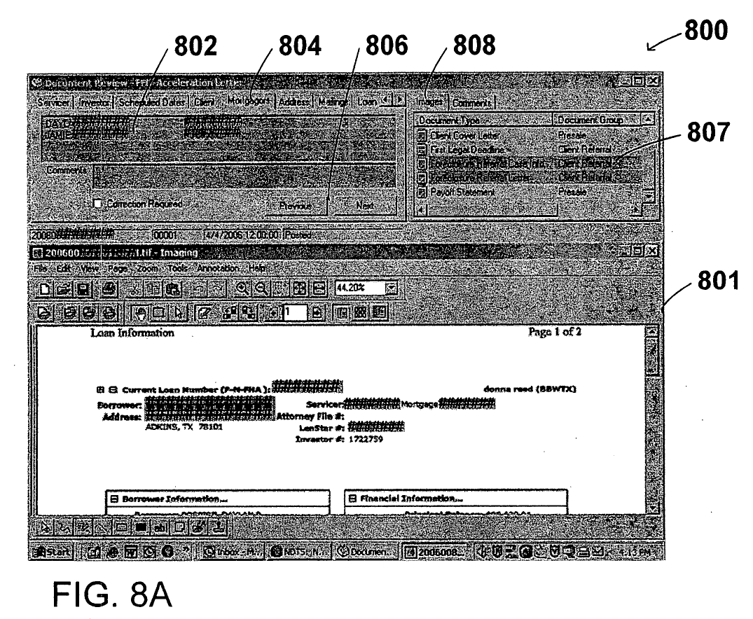

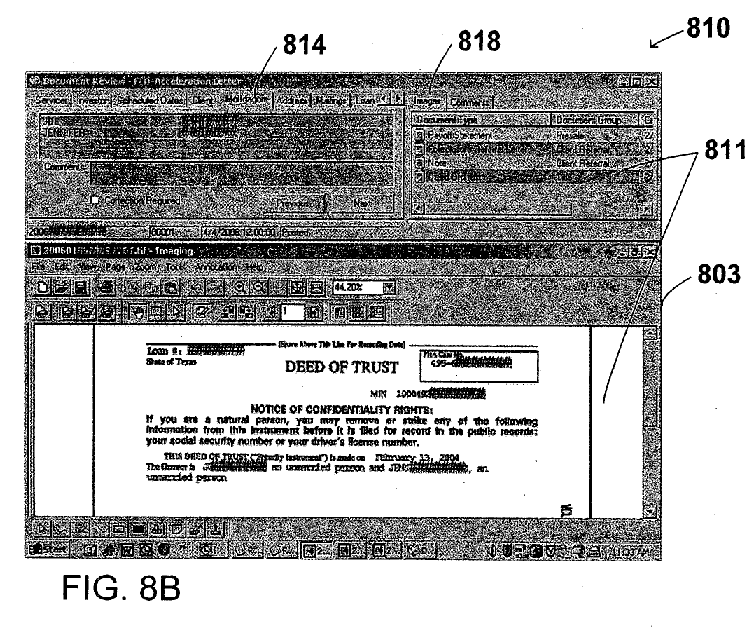

The remaining FIGS. 8A-19 illustrate various states of a user interface panel for reviewing information related to a Federal Fair Debt (FFD) Acceleration letter in an embodiment of the present invention. Although these examples are shown for FFD, the present invention extends the same concepts in scope for virtually any kind of foreclosure notice, and includes embodiments for judicial and non-judicial foreclosure, various types of mortgage or property lien contracts, different types of mortgagee entities (banks, private investors, etc.), and various types of properties (real estate, mobile homes, etc.). The present invention is designed to be adaptable to the laws in all 50 states and other territories of the United States, while other embodiments may also be adapted for foreign laws and jurisdictions.

FIG. 8A shows a user interface panel 800 for reviewing information related to a Federal Fair Debt (FFD) Acceleration letter in accordance with one embodiment of the present invention. In the lower portion of panel 800, a digital image 807 selected from a list in the Image/Comments pane 808 is shown in window 801. In this view, the mortgagors tab 804 is activated, showing the names 802 of all mortgagors on the loan instrument. In panel 801, the loan information on a client referral letter is shown as an image of a document. The buttons for previous and next 806 may be globally used for switching to and from individual functional tabs, such as the mortgagors tab 804.

FIG. 8B illustrates a user interface panel 810 for an active mortgagors tab 814 with a deed of trust 811 selected for viewing in the Images pane 818. The deed of trust is shown in the lower imaging window 803.

FIG. 9A illustrates a user interface panel 900 for reviewing information related to a Federal Fair Debt (FFD) Acceleration letter in accordance with an embodiment of the present invention. The Finish tab 902 is activated showing the final step of electronic signature. The deed of trust 904 is shown in the lower imaging window 803. FIG. 9B illustrates a user interface panel 910 where the View Summary function 906 has been activated. The resulting summary report 908 containing vital information pertinent to the case is shown in the lower imaging window 909.

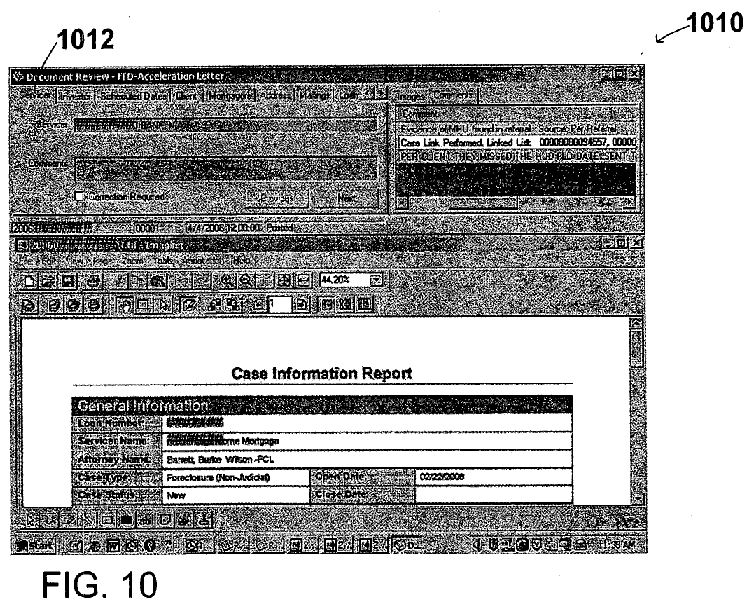

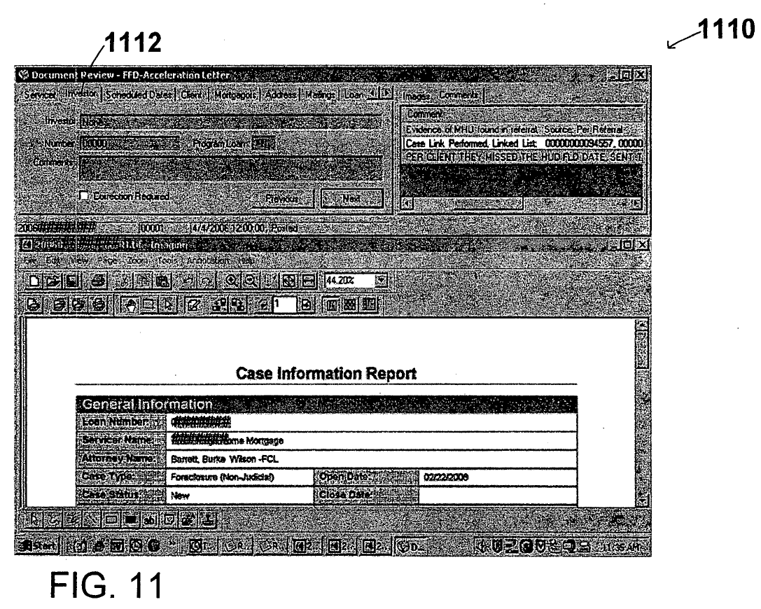

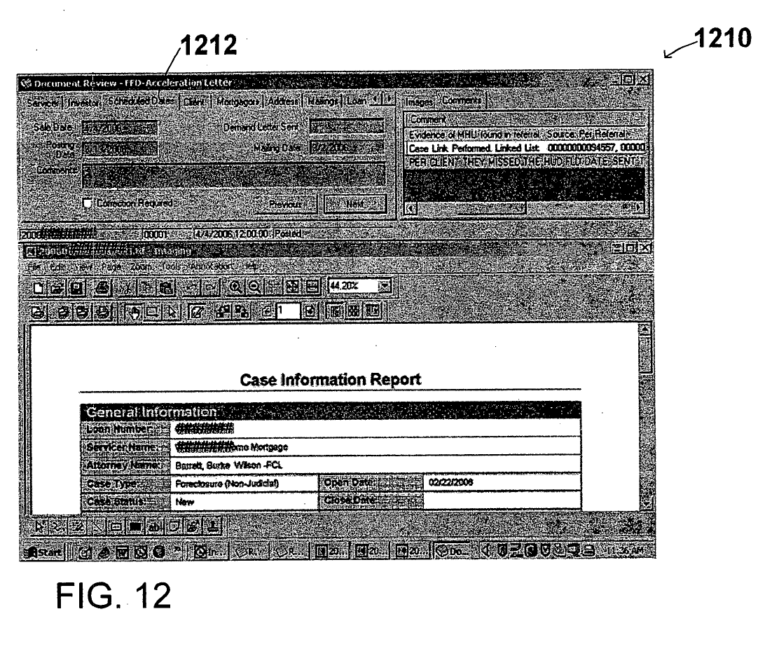

FIG. 10 illustrates a user interface panel 1010 for reviewing information related to a Federal Fair Debt (FFD) Acceleration letter in an embodiment of the present invention. In FIG. 10, the servicer tab 1012 is activated showing the name of the debt servicing entity related to the mortgage. FIG. 11 illustrates a user interface panel 1110 showing the investor tab 1112. FIG. 12 illustrates a schedule dates tab 1212 for user interface 1210.

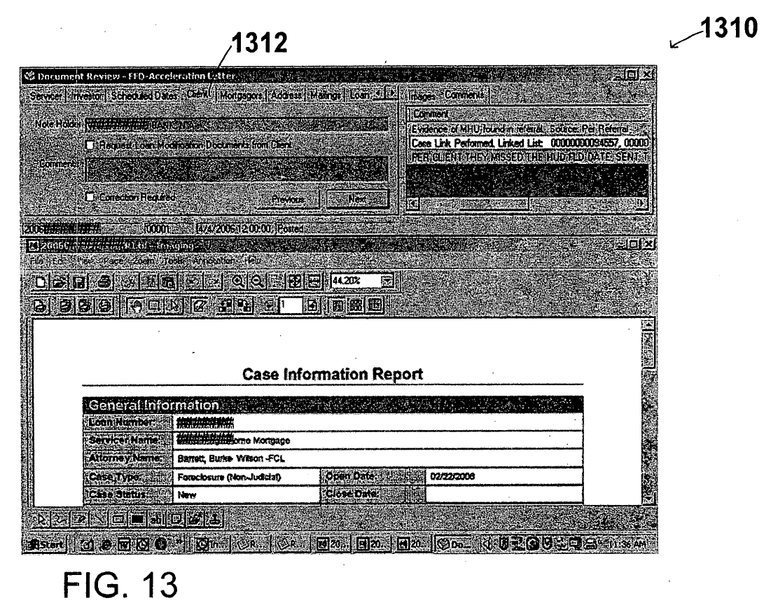

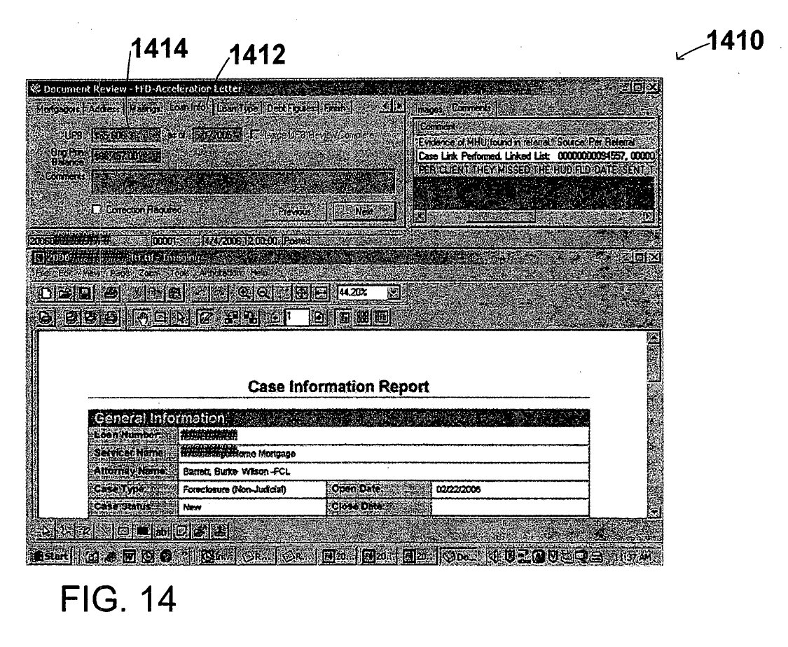

FIG. 13 illustrates a clients tab 1312 for user interface 1310. Note that the client is the referring entity for processing the foreclosure notice, and may or may not be the same entity that is the mortgagee or the debt servicer. The client is generally the party that is billed for the foreclosure notice services, although the costs incurred may be subrogated to the mortgagor. FIG. 14 illustrates the loan information tab 1412 for user interface 1410, showing the actual amount of the loan, the present unpaid balance (UPB) 1414 and the date of the UPB. The costs for issuing the foreclosure notice may be included in the UPB, depending on the business rules that have been established for a particular client.

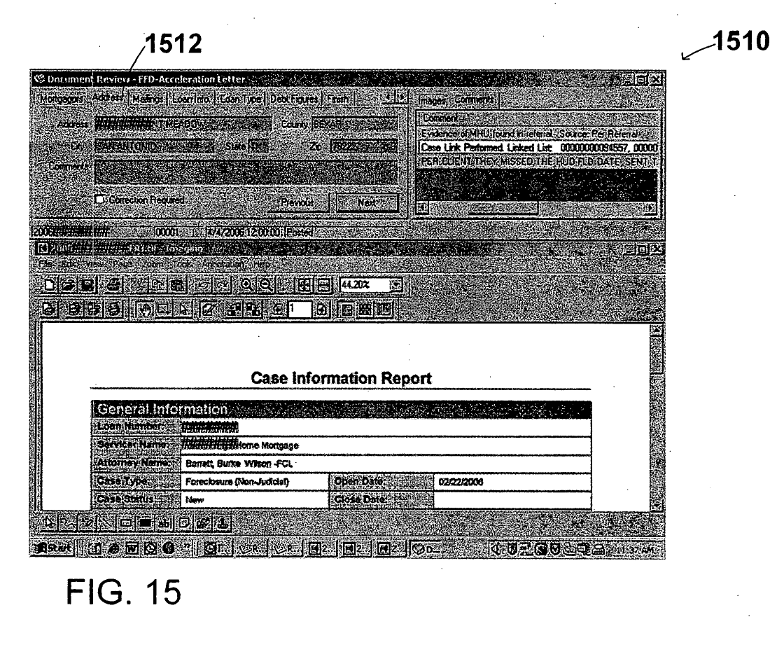

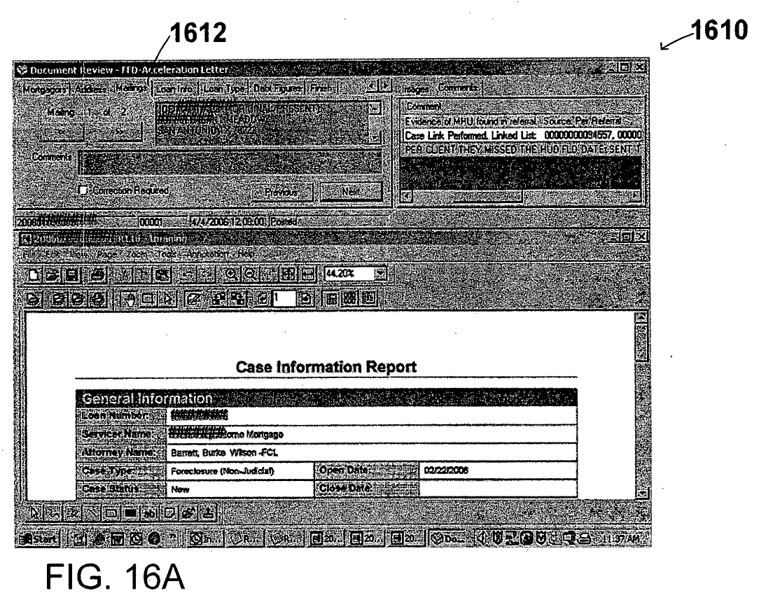

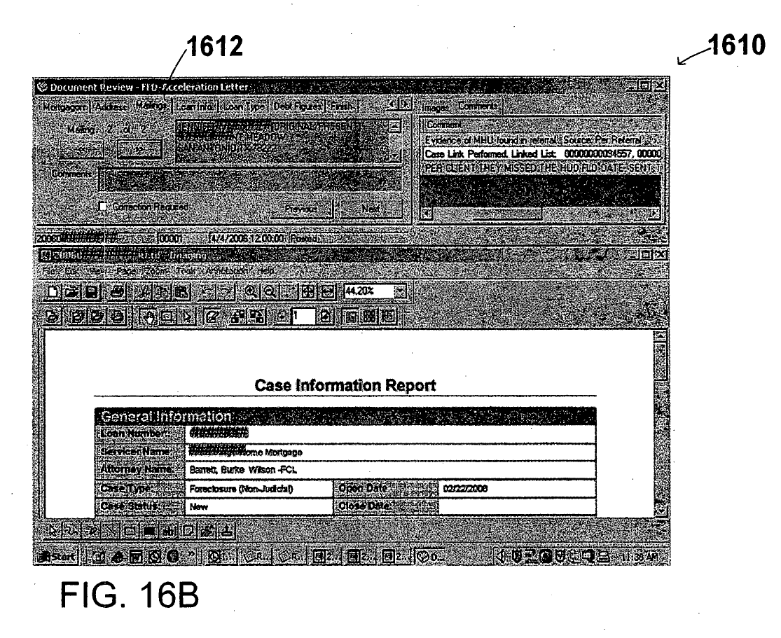

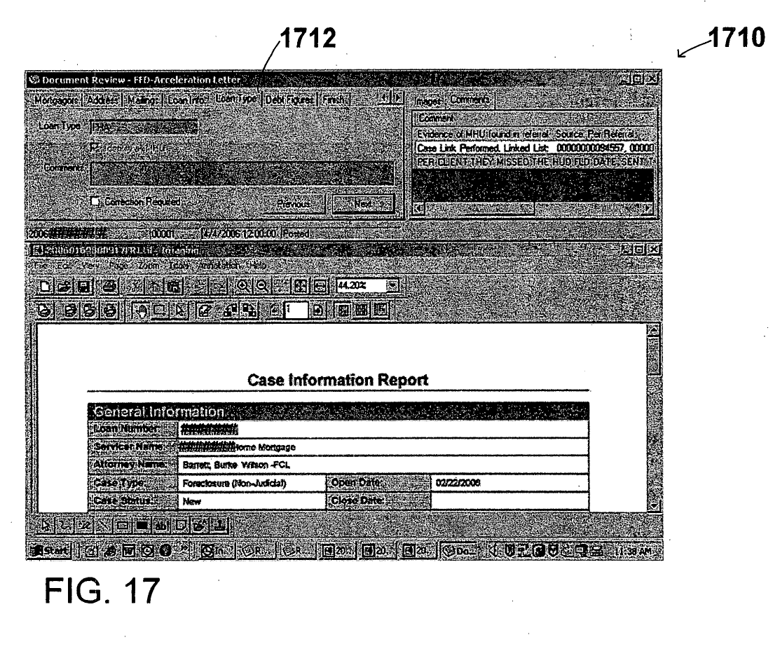

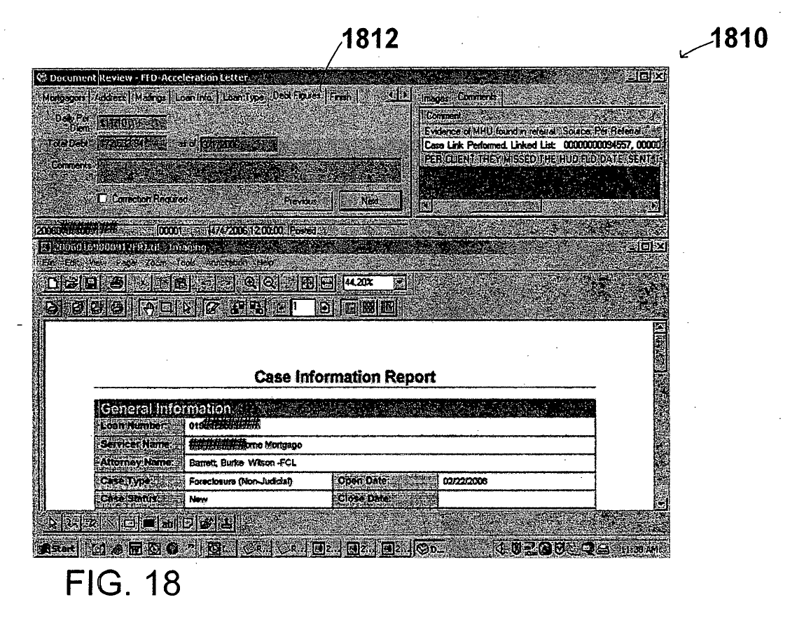

FIG. 15 illustrates an address tab 1412 for user interface 1510 showing the address of the property which is in foreclosure. FIG. 16A illustrates the address tab 1612 for user interface 1610. The invention may accommodate more than one mailing address for issuing each foreclosure notice and the notice may be mailed to multiple addresses. FIG. 16B illustrates the second of two address fields in the address tab 1612 in user interface 1610. FIG. 17 illustrates the loan type tab 1712 for user interface 1710. The tab 1712 is shown with loan type FHA, and there is a provision for indicating if the property is a mobile home unit (MHU). However, the loan type may be one of various types, including VA, FHA, FHA VLB, Conventional, Conventional VLB, VA/VLB, VA vendee, Equity, Equity Second, Second, HELOC, HECM, MHU, Chattel, MHU Realty. The loan type is an important criteria for determining the processing and correspondence required for issuing a foreclosure notice, and business rules are implemented that accommodate for the above-mentioned loan types. Other loan types may be added or modified in further embodiments of the present invention. FIG. 18 illustrates the debt figures tab 1812 for user interface. The debt figures may include the daily per diem and total debt as of a certain date. FIG. 19 illustrates the finish tab 1912 for user interface 1910 showing a previous issues tab 1914 which permits reviewing users to indicate or earmark a case file for a particular issue.

Although the present invention and its advantages have been described in detail, it should be understood that various changes, substitutions and alterations can be made herein without departing from the spirit and scope of the invention as defined by the appended claims. For example, while the invention has been described in relation to processing case files related to foreclosure proceedings, it will become apparent to those skilled in the art that the invention can be adapted or altered to process case files related to bankruptcy proceedings including a MFR and a POC.

1. A method for electronic processing of default case files using a computer system, comprising the steps of:
receiving a default case file;
inputting default information from the default case file to the computer system, the default information comprising data records and digital images from the default case file;
reviewing the data records and digital images to verify the validity and accuracy of the default information;
electronically signing a notice for issue; and
producing the notice using a printer connected to the computer system.

2. The method as recited in claim 1, wherein the default case file is a foreclosure case file.

3. The method as recited in claim 1, wherein the notice is a foreclosure notice being sent to a borrower in default.

4. The method as recited in claim 1, wherein the default case file is a case file related to a bankruptcy proceeding.

5. The method as recited in claim 1, wherein the default case file is related to a Motion for Relief (MFR).

6. The method as recited in claim 1, wherein the default case file is related to a Proof of Claim (POC).

7. A method for electronically reviewing a foreclosure case file comprising data records and digital images of foreclosure related documents and for determining a further course of action based on the review, comprising the steps of:
verifying the validity and accuracy of a foreclosure referral;
verifying the validity and accuracy of a lien instrument;
verifying the validity and accuracy of the name and correspondence address of the borrowing entity;
verifying the validity and accuracy of the physical address of a real property in foreclosure;
verifying the validity and accuracy of deadlines and mandated time periods applicable by law to the foreclosure;
verifying the validity and accuracy of the principal lien balance and loan information;
verifying the validity and accuracy of the type of loan; and
determining a further course of action.

8. The method as recited in claim 7, wherein the further course of action comprises electronically signing a foreclosure notice for issue.

9. The method as recited in claim 7, wherein the further course of action comprises rejecting and returning the foreclosure case file for correction.

10. The method as recited in claim 7, wherein the further course of action comprises suspending the foreclosure pending an action or event in the future.

11. The method as recited in claim 7, wherein the deciding a further course of action is performed by an attorney-at-law.

12. The method as recited in claim 7, wherein the lien instrument comprises one of:
a mortgage; and
a deed of trust.

13. The method as recited in claim 7, wherein a foreclosure may be executed as one of:
a judicial foreclosure; and
a non-judicial foreclosure.

14. A method for electronically preparing a foreclosure case file for electronic review according to a case origination process, comprising the steps of:
receiving a foreclosure referral from a client;
linking the foreclosure referral to previous related case files;
indexing information and documents coupled to the foreclosure referral into the foreclosure case file;
issuing an alphanumeric identifier for the foreclosure case file;
confirming receipt of the foreclosure referral;
generating a time-stamped event log for automatic and manual entry of actions performed during subsequent processing of the foreclosure case file;
generating a plurality of task requests for ordering required foreclosure documents for coupling to the foreclosure case file;
receiving the required foreclosure documents ordered by the plurality of task requests;
determining which further course of action may be taken in the foreclosure in response to information in the foreclosure case file

15. The method as recited in claim 14, wherein the required foreclosure documents comprise:
a mortgage document;
a deed of trust document;
a loan information document;
a title document of record for the real property in foreclosure;
a prior foreclosure document;
a bankruptcy document;
a governmental tax document; and
a document of public record.

16. The method as recited in claim 14, further comprising the step of:
verifying the validity, consistency, and accuracy of the information in the foreclosure case file.

17. The method as recited in claim 16, further comprising one of the steps of:
returning the foreclosure case file for correction; and
forwarding the foreclosure case file for further review.

18. The method as recited in claim 14, wherein the foreclosure referral from a client is received in one of the following forms:
as an electronic notification to manually retrieve a foreclosure referral from a foreign system;
as an electronic foreclosure referral; and
as a foreclosure referral comprising printed documents.

19. A method for automatically generating and issuing a plurality of foreclosure notices according to a document generation process comprising the steps of:
accumulating a plurality of foreclosure case files coupled to a document generation queue, wherein each case file is associated with at least one foreclosure notice ready for printing;
releasing a plurality of foreclosure case files coupled to a document generation queue for printing and mailing;
automatically printing and preparing a plurality of foreclosure notices for mailing in envelopes, wherein postage is electronically charged for each printed foreclosure notice; and
mailing a plurality of foreclosure notices with a postal service, wherein each individual envelope generated is electronically tracked.

20. The method as recited in claim 19, wherein at anytime before actual printing occurs, removing a foreclosure notice from the document generation queue in response to a change in information stored in the foreclosure case file associated with the foreclosure notice.

21. The method as recited in claim 19, further comprising the step of forwarding the foreclosure notice case file for electronic review.

22. The method as recited in claim 19, wherein each electronically tracked envelope is reconciled against each released foreclosure case file coupled to the document generation queue.

23. The method as recited in claim 19, wherein an issued foreclosure notice is returned undelivered by the postal service, further comprising the steps of:
scanning a returned, undelivered foreclosure notice into a digital image; and
coupling the digital image of the returned, undelivered foreclosure notice to the foreclosure case file associated with the returned, undelivered foreclosure notice.

24. The method as recited in claim 19, wherein a printed foreclosure notice is recorded for public notice.

25. The method as recited in claim 19, wherein a printed foreclosure notice is issued to a mortgagor in default.

26. The method as recited in claim 19, wherein the step of automatically printing and preparing a plurality of foreclosure notices further comprises the steps of:
printing a plurality of foreclosure notices containing a barcode identifier;
folding a plurality of foreclosure notices; and
stuffing a plurality of foreclosure notices in envelopes.

27. The method as recited in claim 19, further comprising the step of:
electronically releasing an invoice to bill services related to issuing a foreclosure notice.

28. A method for generating images and indexing documents to foreclosure case files comprising the steps of:
receiving a document as a digital image file;
indexing the digital image file in a database by coupling the digital image file to a case file index;
recording attributes of the digital image file in the database; and
coupling the attributes to the case file index for the digital image file.

29. The method as recited in claim 28, wherein the indexing step is performed automatically in response to one of:
information recorded in the visible image portion of the digital image file;
information recorded in the attributes of the digital image file; and
information associated with the digital image file.

30. The method as recited in claim 28, wherein the receiving step is performed in response to scanning a paper document to generate a digital image file.

31. The method as recited in claim 28, wherein the receiving step is performed in response to virtually printing an electronic document to generate a digital image file.
